(19) United States
(12) Patent Application Publication
(10) Pub. No.: US 2012/0017947 A1
(43) Pub. Date: Jan. 26, 2012

(54) DELIVERY PARTICLE

(76) Inventors: Susana FERNANDEZ PRIETO, Benicarlo-Castellon (ES); Alberto Simoncelli, Wezembeek-Oppem (BE); Jose Luis Vega, Kraainem (BE); Johan Smets, Lubbeek (BE)

(21) Appl. No.: 13/186,530

(22) Filed: Jul. 20, 2011

Related U.S. Application Data
(60) Provisional application No. 61/365,903, filed on Jul. 20, 2010.
(60) Provisional application No. 61/368,001, filed on Jul. 27, 2010.

(51) Int. Cl. B08B 3/00; B05D 1/02; B05D 7/00; C11D 3/60; B65D 85/84

(52) U.S. Cl. 134/26; 510/513; 510/530; 510/392; 510/367; 510/375; 510/376; 510/374; 206/524.7; 427/212

(57) ABSTRACT

The present application relates to delivery particles comprising benefit agents, and products comprising such delivery particles, as well as processes for making and using such delivery particles and products comprising such delivery particles. The process of making such particles does not unduly degrade the benefit agent and when such particles are employed in a product, they are stable, yet they release the desired amount of benefit agent when such product is used as intended.

### CROSS-REFERENCE TO RELATED APPLICATIONS

This application claims priority under 35 U.S.C. §119(e) to U.S. Provisional Application Ser. No. 61/365,903 filed Jul. 20, 2010, and U.S. Provisional Application Ser. No. 61/368,001 filed Jul. 27, 2010.

### FIELD OF INVENTION

The present application relates to delivery particles comprising benefit agents, and products comprising such delivery particles, as well as processes for making and using such delivery particles and products comprising such delivery particles.

### BACKGROUND OF THE INVENTION

Products, for example, consumer products may comprise one or more benefit agents that can provide a desired benefit to such product and/or a situs that is contacted with such a product—for example stain removal and/or bleaching. Unfortunately, in certain products, for example, fluid products, benefit agents such as preformed peracids may be degraded by or degrade components of such products before such product is used—this is particularly true when the product has a pH greater than about 6. Thus, a protection system that protects the components of a product from a benefit agent is desired. Efforts have been made in this area but typically either fail to provide the required level of protection or fail to release the benefit agent when it is needed. Thus, the need for encapsulated benefit agents that are available during product use, yet which do not damage such product during product storage remains. Applicants disclose a delivery particle comprising a benefit agent, such as preformed peracids, wherein the benefit agent is in the form of cores, said cores being embedded in a matrix binder. Combined, the benefit agent cores and matrix binder form a matrix that is encapsulated by a shell. While not being bound by theory, Applicants believe that the shell services as a barrier to the particle's environment and the matrix binder serves as a material sink that absorbs any material from the particle's environment that passes through the shell. The shell and matrix binder materials are chosen such that the particle is stable in a product, such as a consumer product, during storage, yet the particle releases the benefit agent during use. Surprisingly, the process of making such particles does not unduly degrade the benefit agent and when such particles are employed in a product, they are stable, yet they release the desired amount of benefit agent when such product is used as intended.

### SUMMARY OF THE INVENTION

The present application relates to particles comprising a benefit agent encapsulated by a first layer that is in turn encapsulated by a second material, and products comprising such particles, as well as processes for making and using such particles and products comprising such particles.

### BRIEF DESCRIPTION OF THE DRAWINGS

FIG. 1 depicts a representative delivery particle having a matrix encapsulated by a shell.

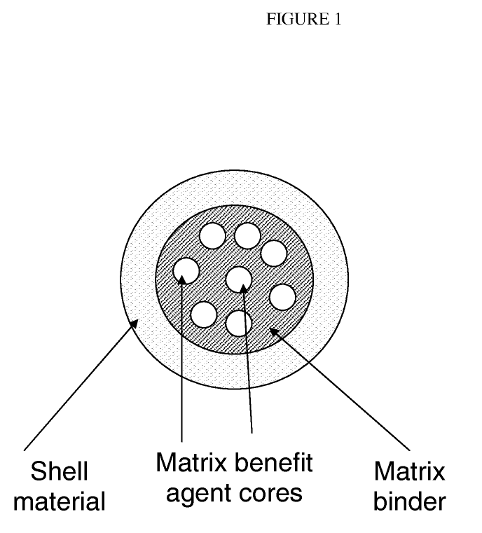

FIG. 2 depicts a representative delivery particle having a plurality of matrices encapsulated by/embedded in a shell.

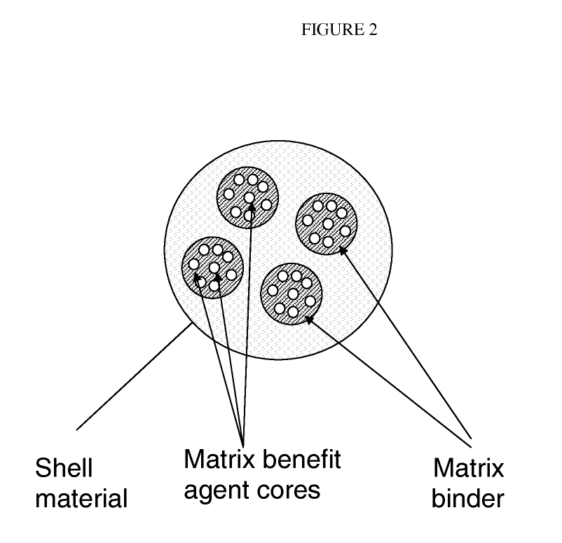

### DETAILED DESCRIPTION OF THE INVENTION

### Definitions

As used herein “consumer product” means baby care, beauty care, fabric & home care, family care, feminine care, health care, or devices generally intended to be used in the form in which it is sold. Such products include but are not limited to diapers, bibs, wipes; products for and/or methods relating to treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use including fine fragrances; and shaving products, products for and/or methods relating to treating fabrics, hard surfaces and any other surfaces in the area of fabric and home care, including: air care including air fresheners and scent delivery systems, car care, dishwashing, fabric conditioning (including softening and/or freshing), laundry detergency, laundry and rinse additive and/or care, hard surface cleaning and/or treatment including floor and toilet bowl cleaners, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; over-the-counter health care including cough and cold remedies, pain relievers, RX pharmaceuticals.

As used herein, the term “cleaning and/or treatment composition” is a subset of consumer products that includes, unless otherwise indicated, beauty care, fabric & home care products. Such products include, but are not limited to, products for treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use including fine fragrances; and shaving products, products for treating fabrics, hard surfaces and any other surfaces in the area of fabric and home care, including: air care including air fresheners and scent delivery systems, car care, dishwashing, fabric conditioning (including softening and/or freshing), laundry detergency, laundry and rinse additive and/or care, hard surface cleaning and/or treatment including floor and toilet bowl cleaners, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, dentifrice, car or carpet shampoos, bathroom cleaners including toilet bowl cleaners; hair shampoos and hair-rinses; shower gels, fine fragrances and foam baths and metal cleaners; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists all for consumer or/and institutional use; and/or methods relating to oral care including toothpastes, tooth gels, tooth rinses, denture adhesives, tooth whitening.

As used herein, the term “fabric and/or hard surface cleaning and/or treatment composition” is a subset of cleaning and treatment compositions that includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, car or carpet shampoos, bathroom cleaners including toilet bowl cleaners; and metal cleaners, fabric conditioning products including softening and/or freshing that may be in liquid, solid and/or dryer sheet form; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists. All of such products which are applicable may be in standard, concentrated or even highly concentrated form even to the extent that such products may in certain aspect be non-aqueous.

As used herein, articles such as “a” and “an” when used in a claim, are understood to mean one or more of what is claimed or described.

As used herein, the terms “include”, “includes” and “including” are meant to be non-limiting.

As used herein, the term “solid” includes granular, powder, bar and tablet product forms.

As used herein, the term “fluid” includes liquid, gel, paste and gas product forms.

As used herein, the term “situs” includes paper products, fabrics, garments, hard surfaces, hair and skin.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Consumer Products

In one aspect, a delivery particle comprising a shell material and one or more matrices, said shell encapsulating or embedding said one or more matrices, said one or more matrices comprising one or more matrix binders and a plurality of matrix benefit agent cores, said matrix benefit agent cores being dispersed in said one or more matrix binders, said delivery particle having a mean particle size distribution of from about 10 microns to about 250 microns, from about 20 microns to about 150 microns, or even from about 35 microns to about 90 microns is disclosed.

In one aspect of said delivery particle, said matrix binder may comprise a sink for small molecules, said molecules may have a molecular weight from about 500 grams/mol to about 18 grams/mol, from about 300 grams/mol to about 18 grams/mol, or even from about 100 grams/mol to about 28 grams/mol. In one aspect, said small molecules may be selected from water, an organic material and mixtures thereof. In one aspect, said organic material may be selected from the group consisting of ethanol, propylene glycol, ethyl acetate, trans-2-hexanal, cis-3 hexenol, methyl heptenone, cinnamalva, benzaldehyde, benzyl alcohol and mixtures thereof. Without being limited by theory, it is believed that small molecules are drawn into the network across a diffusion gradient, said network formed by the matrix binder, and said matrix binder swells and may even promote sealing of the interface between the matrix and the shell. Swelling can be measured using the centrifuge retention test method further detailed hereinafter.

In one aspect of said delivery particle:
a) said matrix binder may comprise a material selected from a water soluble and/or water dispersible non-reducing polysaccharide, a water soluble and/or water dispersible acrylate derivative and mixtures thereof;
b) said shell material may comprise a material selected from the group consisting of polyvinyl alcohol, polyvinyl acetate, cellulose acetate, poly(vinyl-alcohol-co-vinylacetate), acrylic acid-ethylene-vinyl acetate copolymer and mixtures thereof; and
c) said matrix benefit agent core may comprise a material selected from the group consisting of a preformed peracid, a metal catalyst, a bleach activator, a bleach booster, a diacyl peroxide, a hydrogen peroxide source and an enzyme.

In one aspect of said delivery particle:
a) said metal catalyst may comprise a material selected from the group consisting of dichloro-1,4-diethyl-1,4,8,11-tetraaazabicyclo[6.6.2]hexadecane manganese(II); dichloro-1,4-dimethyl-1,4,8,11-tetraaazabicyclo[6.6.2]hexadecane manganese(II) and mixtures thereof;
b) said bleach booster may comprise material selected from the group consisting of 2-[3-[(2-hexyldodecyl)oxy]-2-(sulfooxy)propyl]-3,4-dihydroisoquinolinium, inner salt; 3,4-dihydro-2-[3-[(2-pentylundecyl)oxy]-2-(sulfooxy)propyl]isoquinolinium, inner salt; 2-[3-[(2-butyldecyl)oxy]-2-(sulfooxy)propyl]-3,4-dihydroisoquinolinium, inner salt; 3,4-dihydro-2-[3-(octadecyloxy)-2-(sulfooxy)propyl]isoquinolinium, inner salt; 2-[3-(hexadecyloxy)-2-(sulfooxy)propyl]-3,4-dihydroisoquinolinium, inner salt; 3,4-dihydro-2-[2-(sulfooxy)-3-(tetradecyloxy)propyl]isoquinolinium, inner salt; 2-[3-(dodecyloxy)-2-(sulfooxy)propyl]-3,4-dihydroisoquinolinium, inner salt; 2-[3-[(3-hexyldecyl)oxy]-2-(sulfooxy)propyl]-3,4-dihydroisoquinolinium, inner salt; 3,4-dihydro-2-[3-[(2-pentylnonyl)oxy]-2-(sulfooxy)propyl]isoquinolinium, inner salt; 3,4-dihydro-2-[3-[(2-propylheptyl)oxy]-2-(sulfooxy)propyl]isoquinolinium, inner salt; 2-[3-[(2-butyloctyl)oxy]-2-(sulfooxy)propyl]-3,4-dihydroisoquinolinium, inner salt; 2-[3-(decyloxy)-2-(sulfooxy)propyl]-3,4-dihydroisoquinolinium, inner salt; 3,4-dihydro-2-[3-(octyloxy)-2-(sulfooxy)propyl]isoquinolinium, inner salt; 2-[3-[(2-ethylhexyl)oxy]-2-(sulfooxy)propyl]-3,4-dihydroisoquinolinium, inner salt and mixtures thereof;
c) said bleach activator may comprise a material selected from the group consisting of tetraacetyl ethylene diamine (TAED); benzoylcaprolactam (BzCL); 4-nitrobenzoylcaprolactam; 3-chlorobenzoylcaprolactam; benzoyloxybenzenesulphonate (BOBS); nonanoyloxybenzenesulphonate (NOBS); phenyl benzoate (PhBz); decanoyloxybenzenesulphonate (C10-OBS); benzoylvalerolactam (BZVL); octanoyloxybenzenesulphonate (C8-OBS); perhydrolyzable esters; 4-[N-(nonaoyl)amino hexanoyloxy]-benzene sulfonate sodium salt (NACA-OBS); dodecanoyloxybenzenesulphonate (LOBS or C12-OBS); 10-undecenoyloxybenzenesulfonate (UDOBS or C11-OBS with unsaturation in the 10 position); decanoyloxybenzoic acid (DOBA); (6-octanamidocaproyl)oxybenzenesulfonate; (6-nonanamidocaproyl) oxybenzenesulfonate; (6-decanamidocaproyl)oxybenzenesulfonate and mixtures thereof;
d) said preformed peracid may comprise a material selected from the group consisting of peroxymonosulfuric acids; perimidic acids; percabonic acids; percarboxilic acids and salts of said acids; in one aspect said percarboxilic acids and salts thereof comprises phthalimidoperoxyhexanoic acid, 1,12-diperoxydodecanedioic acid; or monoperoxyphthalic acid (magnesium salt hexahydrate); amidoperoxyacids, in one aspect, said amidoperoxyacids comprises N,N′-terephthaloyl-di(6-aminocaproic acid), a monononylamide of either peroxysuccinic acid (NAPSA) or of peroxyadipic acid (NAPAA), N-nonanoylaminoperoxycaproic acid (NAPCA), and mixtures thereof; in one aspect, said preformed peracid may comprise phthalimidoperoxyhexanoic acid; suitable phthalimidoperoxyhexanoic acids includes EURECO™ W, EURECO™ WM1, EURECO™ LX and mixtures thereof;
e) said diacyl peroxide may comprise a material selected from the group consisting of dinonanoyl peroxide, didecanoyl peroxide, diundecanoyl peroxide, dilauroyl peroxide, dibenzoyl peroxide, di-(3,5,5-trimethyl hexanoyl) peroxide and mixtures thereof; in one aspect, said diacyl peroxide comprises a clathrated diacyl peroxide;
f) said hydrogen peroxide source may comprise a material selected from the group consisting of a perborate, a percarbonate, a peroxyhydrate, a persulfate and mixtures thereof, in one aspect said hydrogen peroxide source comprises sodium perborate, in one aspect said sodium perborate comprises a mono- or tetra-hydrate, sodium pyrophosphate peroxyhydrate, urea peroxyhydrate or trisodium phosphate peroxyhydrate and mixtures thereof; and
g) said enzyme may comprise a material selected from the group consisting of peroxidases, proteases, lipases, phospholipases, cellobiohydrolases, cellobiose dehydrogenases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccases, amylases, and mixtures thereof.

In one aspect of said delivery particle, said matrix benefit agent core may comprise a combination of said matrix benefit agent core materials. In one aspect, said matrix benefit agent core materials may be agglomerated. In one aspect, said combination of said core materials being embedded in said matrix binder forming a matrix, and said matrix being encapsulated by said shell.

In one aspect of said delivery particle:
a) said polyvinyl alcohol may comprise a polyvinyl alcohol variant having a degree of hydrolysis from about 80 mol % to about 99 mol %, or from about 87 mol % to about 89 mol %; and a molecular weight from about 10,000 gram/mol to about 750,000 gram/mol, or from about 30,000 gram/mol to about 300,000 gram/mol.
b) said polyvinyl acetate may comprise a polyvinyl acetate variant having a degree of polymerization from about 150 to 5,000, from about 150 to 2,000 or even from about 190 to about 1,000.
c) said cellulose acetate may comprise a cellulose acetate variant having a molecular weight from about 30,000 to about 50,000 gram/mol.

In one aspect of said shell, said shell may comprise a material that is not pH sensitive in the pH range of from about 4 to about 9.

In one aspect of said shell, said shell may comprise a good film forming polymer.

In one aspect of said shell, said shell may comprise a polymer with a dielectric constant from about 3.2 to about 9.3.

In one aspect of said delivery particle, said shell may additionally comprise an organoclay that may reduce the dielectric constant of a polymer of said shell. A suitable organoclay may comprise a montmorillonite clay that has been organically modified, for example with a fatty amine.

In one aspect of said delivery particle:
a) said water soluble and/or water dispersible non-reducing polysaccharide may comprise a material selected from the group consisting of xanthan gum, diutan gum, guar gum, gellan gum, carrageenan, synergistic gum systems and mixtures thereof. Suitable xanthan gums include Kelzan® ASX-T, Kelzan® ASX, Kelzan® HP-T, Ticaxan®, suitable gellan gums include Kelcogel® CG-LA, Kelcogel® CG-HA, suitable carrageenan gums include Genuvisco®, Genugel®, suitable synergistic gum systems include Action gum; and
b) said water soluble and/or water dispersible acrylate derivative may have a glass transition temperature from about 50° C. to about 130° C., or even from about 90° C. to about 115° C. Without being limited by theory, it is believed that water soluble and/or water dispersible acrylate derivatives have better film forming properties and a higher swelling capacity when the temperature during the particle's making process is below the glass transition temperature of such materials. Suitable acrylate derivatives include Alcogum® L-31, Alcogum® L-229, Alcogum® L-299, Alcogum® 1370, Alcogum® L-255, Alcogum® L-237, Alcogum® L-251, Alcogum® L-296-W, Acusol™ 820, and Acusol™ 801S.

In one aspect of said delivery particle, said matrix binder may comprise a solid material at a temperature of from about 20° C. to about 150° C., or even from about 60° C. to about 150° C.

In one aspect of said delivery particle, said matrix binder may comprise an anionic non-reducing polysaccharide.

In one aspect of said delivery particle, said matrix binder may comprise an anionic non-reducing polysaccharide that may be encapsulated by a shell material that masks the (negative) charge of said anionic non-reducing polysaccharide, such as a shell material comprising a polymer with a dielectric constant from about 3.2 to about 8.3.

In one aspect of said delivery particle, said matrix binder may have a centrifuge retention capacity from about 2 gram/gram to about 500 gram/gram, from about 10 gram/gram to about 300 gram/gram, or even from about 50 gram/gram to about 150 gram/gram.

In one aspect, of said delivery particle, said delivery particle may comprise:
a) a single matrix that may comprise one or more matrix binders and a plurality of matrix benefit agent cores that may comprise the same or a different material; or
b) a plurality of matrices, each of said matrices independently may comprise one or more matrix binders and a plurality matrix benefit agent cores that may comprise the same or a different material, said plurality of matrices being encapsulated by or embedded in said shell material.

In one aspect of said delivery particle, said plurality of matrix benefit agent cores may comprise the same or a different material that may be a benefit agent.

In one aspect of said delivery particle, said delivery particle may have a stability index of from about 0.80 to about 1, from about 0.90 to about 1, or even from about 0.95 to about 1.

In one aspect of said delivery particle, said delivery particle may have a release index of from about 0.25 to about 1, from about 0.50 to about 1, or even from about 0.85 to about 1.

In one aspect of said delivery particle, said delivery particle may have a matrix to shell material mass ratio of from about 20:80 to about 90:5, from about 35:65 to about 90:10, or even from about 45:55 to about 80:20.

In one aspect of said delivery particle, said delivery particle may have a matrix binder to shell mass ratio of from about 50:50 to about 3:97, from about 35:65 to 10:90, or even from about 22:75 to about 15:85.

In one aspect of said delivery particle, said delivery particle may comprise an additional outer layer, said outer layer may comprise a second shell material, a deposition aid polymer and/or mixtures thereof, in one aspect, said outer layer may be completely or partially coating and/or encapsulating said delivery particle. In one aspect, said second shell material may comprise polyvinyl alcohol, polyvinyl acetate, cellulose acetate, poly(vinyl-alcohol-co-vinylacetate), acrylic acid-ethylene-vinyl acetate copolymer, shellac, hydroxypropylmethyl cellulose phthalate, cellulose acetate phthalate, lignin and mixtures thereof. In one aspect, said deposition aid polymer may comprise a cationic polymer, an anionic polymer or mixtures thereof. Without being limited by theory, it is believed that said deposition aid polymer may improve matrix benefit agent core deposition on surfaces improving cleaning performance.

In one aspect of said deposition aid polymer, said cationic polymer may comprise:
a) a moiety selected from the group consisting of a quaternary ammonium, a protonated primary amine, a protonated secondary amine, a protonated tertiary amine and combinations thereof; and
b) said anionic polymer may comprise a moiety selected from the group consisting of an unprotonated carboxylic group, an unprotonated alcohol group, an unprotonated thiol group, an unprotonated primary amine, an unprotonated secondary amine and combinations thereof.

In one aspect of said delivery particle:
a) said cationic polymer may comprise a material selected from the group consisting of:
   (i) a protein, in one aspect, a poly peptide;
   (ii) a polysaccharide, in one aspect, said polysaccharide may comprise a material selected from the group consisting of starch, guar, cellulose and mixtures thereof, in one aspect, said cellulose may comprise hydroxyl ethyl cellulose
   (iii) a polyamide;
   (iv) a poly(metha)acrylamide;
   (v) a polyether;
   (vi) a polyester;
   (vii) a polyoxymethylene;
   (viii) a silicone;
   (ix) a polyurethane;
   (x) a polyvinylether;
   (xi) a polyethylene (propylene) oxide;
   (xii) a polyvinyl alcohol;
   (xiii) a polyvinyl acetate;
   (xiv) a polyvinyl formal;
   (xv) a polyvinyl butyral;
   (xvi) a polyvinylmethylether;
   (xvii) a polyvinylpyrrolidone;
   (xviii) a polyvinylmethyl oxazolidone;
   (xix) a polyvinylamine;
   (xx) a polyvinylpyridine;
   (xxi) a polyimidazoline;
   (xxii) a poly(diallyldimethylammonium chloride) (DAMAC);
   (xxiii) poly(N,N-dimethyl-3,5-methylenepiperidimium chloride);
   (xxiv) copolymers of polyvinylamine and polyyinylalcohol
   (xxv) oligomers of amines, in one aspect a diethylenetriamine, ethylene diamine, bis(3-aminopropyl)piperazine, N,N-Bis-(3-aminopropyl)methylamine, tris(2-aminoethyl)amine and mixtures thereof;
   (xxvi) a polyethyleneimime
   (xxvii) a derivatized polyethyleneimine, in one aspect an ethoxylated polyethyleneimine;
   (xxviii) a cationic surfactant, in one aspect;
   (xxix) a polymeric compound may comprise, at least two moieties selected from the moieties consisting of a carboxylic acid moiety, an amine moiety, a hydroxyl moiety, and a nitrile moiety on a backbone of polybutadiene, polyisoprene, polybutadiene/styrene, polybutadiene/acrylonitrile, carboxyl-terminated polybutadiene/acrylonitrile or combinations thereof; and
   (xxx) mixtures and/or co-polymers thereof; and
b) said anionic polymer may comprise a material selected from the group consisting of:
   (i) a protein, in one aspect, a poly peptide;
   (ii) a polysaccharide, in one aspect, said polysaccharide may comprise a material selected from the group consisting of starch, guar, cellulose and mixtures thereof, in one aspect, said cellulose may comprise carboxylmethyl cellulose
   (iii) a polyamide;
   (iv) a poly(metha)acrylamide;
   (v) a polyether;
   (vi) a polyester;
   (vii) a polyoxymethylene;
   (viii) a silicone;
   (ix) a polyurethane;
   (x) a polyvinylether;
   (xi) a polyethylene (propylene) oxide;
   (xii) a polyvinyl alcohol;
   (xiii) a polyvinyl acetate;
   (xiv) a polyvinyl formal;
   (xv) a polyvinyl butyral;
   (xvi) a polyvinylmethylether;
   (xvii) a polyvinylpyrrolidone;
   (xviii) a polyvinylmethyl oxazolidone;
   (xix) a polyvinylamine;
   (xx) a polyvinylpyridine;
   (xxi) a polyacrylate,
   (xxii) copolymers of polyvinylamine and polyyinylalcohol
   (xxiii) a polymeric compound comprising, at least two moieties selected from the moieties consisting of a carboxylic acid moiety, an amine moiety, a hydroxyl moiety, and a nitrile moiety on a backbone of polybutadiene, polyisoprene, polybutadiene/styrene, polybutadiene/acrylonitrile, carboxyl-terminated polybutadiene/acrylonitrile or combinations thereof; and
   (xxiv) mixtures and/or co-polymers thereof.

In one aspect of said delivery particle:
a) said cationic polymer may comprise a material selected from the group consisting of a polypeptide; a starch, a guar, a cellulose and mixtures thereof; and
b) said anionic polymer may comprise a material selected from the group consisting of: a polypeptide; a starch, a guar, a cellulose and mixtures thereof.

In one aspect of said delivery particle:
a) said cationic polymer may comprise hydroxylethyl cellulose; and
b) said anionic polymer may comprise carboxylmethyl cellulose.
   In one aspect of said delivery particle, said deposition aid polymer may comprise one or more efficiency polymers having the following formula:

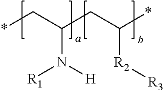

wherein:
a) “a” and “b” are integers or averages (real numbers) from about 50-100,000;
b) each R₁ is independently selected from H, CH₃, (C═O)H, alkylene, alkylene with unsaturated C—C bonds, CH₂—CROH, (C═O)—NH—R, (C═O)—(CH₂)ₙ—OH, (C═O)—R, (CH₂)ₙ-E, —(CH₂—CH(C═O))ₙ—XR, —(CH₂)ₙ—COOH, —(CH₂)ₙ—NH₂, —CH₂)ₙ—(C═O)NH₂, the index “n” is an integer from about 0 to about 24, E is an electrophilic group; R is a saturated or unsaturated alkane, dialkylsiloxy, dialkyloxy, aryl, alkylated aryl, that may further contain a moiety selected from the group consisting of cyano, OH, COOH, NH₂, NHR, sulfonate, sulphate, —NH₂, quaternized amines, thiols, aldehyde, alkoxy, pyrrolidone, pyridine, imidazol, imidazolinium halide, guanidine, phosphate, monosaccharide, oligo or polysaccharide;
c) R₂ or R₃ can be absent or present:
   (i) when R₃ is present each R₂ is independently selected from the group consisting of —NH₂, —COO—, —(C═O)—, —O—, —S—, —NH—(C═O)—, —NR₁—, dialkylsiloxy, dialkyloxy, phenylene, naphthalene, alkyleneoxy; and each R₃ is independently selected the same group as R₁;
   (ii) when R₃ is absent each R₂ is independently selected from the group consisting of —NH₂, —COO—, —(C═O)—, —O—, —S—, —NH—(C═O)—, —NR₁—, dialkylsiloxy, dialkyloxy, phenylene, naphthalene, alkyleneoxy; and each R₃ is independently selected the same group as R₁; and
   (iii) when R₂ is absent, each R₃ is independently selected the same group as R₁;
d) said one or more efficiency polymers may have an average molecular mass from about 1,000 Da to about 50,000,000 Da, from about 5,000 Da, to about 25,000,000 Da, from about 10,000 Da to about 10,000,000 Da, or even from about 340,000 Da to about 1,500,000 Da; a hydrolysis degree, for polyvinyl formamides, of from about 5% to about 95%, from about 7% to about 60%, or even from about 10% to about 40%; and/or a charge density from about 1 meq/g efficiency polymer to about 23 meq/g efficiency polymer, from about 1.2 meq/g efficiency polymer to about 16 meq/g efficiency polymer, from about 2 meq/g efficiency polymer to about 10 meq/g efficiency polymer, or even from about 1 meq/g efficiency polymer to about 4 meq/g efficiency polymer.

In one aspect of said delivery particle, said one or more efficiency polymers may be selected from the group consisting of polyvinyl amines, polyvinyl formamides, and polyallyl amines and copolymers thereof, said one or more efficiency polymers may have:
a) an average molecular mass from about 1,000 Da to about 50,000,000 Da, from about 5,000 Da, to about 25,000,000 Da, from about 10,000 Da to about 10,000,000 Da, or even from about 340,000 Da to about 1,500,000 Da;
b) a hydrolysis degree, for said polyvinyl formamides, of from about 5% to about 95%, from about 7% to about 60%, or even from about 10% to about 40%; and/or
c) a charge density from about 1 meq/g efficiency polymer to about 23 meq/g efficiency polymer, from about 1.2 meq/g efficiency polymer to about 16 meq/g efficiency polymer, from about 2 meq/g efficiency polymer to about 10 meq/g efficiency polymer, or even from about 1 meq/g efficiency polymer to about 4 meq/g efficiency polymer.

In one aspect of said delivery particle, said deposition aid polymer may comprise one or more polyvinyl formamides said polyvinyl formamides may have:
a) an average molecular mass from about 1,000 Da to about 50,000,000 Da, from about 5,000 Da to about 25,000,000 Da, from about 10,000 Da to about 10,000,000 Da, or even from about 340,000 Da to about 1,500,000 Da;
b) a hydrolysis degree, for said polyvinyl formamides, of from about 5% to about 95%, from about 7% to about 60%, or even from about 10% to about 40%; and
c) a charge density from about 1 meq/g efficiency polymer to about 23 meq/g efficiency polymer, from about 1.2 meq/g efficiency polymer to about 16 meq/g efficiency polymer, from about 2 meq/g efficiency polymer to about 10 meq/g efficiency polymer, or even from about 1 meq/g efficiency polymer to about 4 meq/g efficiency polymer.

In one aspect of a consumer product, said consumer product may comprise said delivery particle and an adjunct ingredient.

In one aspect of said consumer product, said consumer product may comprise a material selected from the group consisting of an external structuring system, an anti-agglomeration agent and mixtures thereof.

In one aspect of said consumer product, said external structuring system may comprise a hydrogenated castor oil derivative.

In one aspect of said consumer product, said consumer product may comprise a material selected from:
a) an anionic surfactant and/or a nonionic, in one aspect an anionic surfactant;
b) a solvent, in one aspect said solvent may comprise butoxypropoxypropanol and/or glycerol;
c) water, in one aspect, based on total composition weight, less than about 10% water or from about 2% to about 10% water;
d) optionally, one or more materials selected from the group consisting of:
   (i) a bleach compatible clay clean polymer, in one aspect said bleach compatible clay clean polymer may be selected from the group consisting of ethoxylated hexamethylene diamine dimethyl quat, ethoxysulfated hexamethylene diamine dimethyl quat and mixtures thereof.
   (ii) a brightener, in one aspect said brightener may comprise a fluorescent brightener selected from disodium 4,4′-bis(2-sulfostyryl)biphenyl and/or bis(sulfobenzofuranyl)biphenyl.
   (iii) a builder, in one aspect said builder may comprise sodium citrate
   (iv) a chelant, in one aspect said chelant may comprise 1-Hydroxy Ethylidene-1,1-Diphosphonic Acid (HEDP)

In one aspect of said consumer product, said consumer product may comprise:
a. from 0.0001% to 8% by weight of a detersive enzyme, and
b. a neat pH from 6.5 to 10.5.

In one aspect of said consumer product, said detersive enzyme may comprise an enzyme selected from the group consisting of: lipase, protease, amylase, cellulase, pectate lyase, xyloglucanase, and mixtures thereof.

In one aspect of said consumer product, said consumer product may comprise:
a. from 0.1% to 12% by weight of the bleach or bleach system, and
b. a neat pH of from 6.5 to 10.5.

In one aspect of said consumer product, said consumer product may be enclosed within a water soluble pouch material, in one aspect, said pouch material may comprise a polyvinyl alcohol, a polyvinyl alcohol copolymer, hydroxypropyl methyl cellulose (HPMC) and mixtures thereof.

The suitable materials and equipment for practicing the present invention may be obtained from: Germany SSB, Stroever GmbH & Co. KG, Muggenburg 11, 28217 Bremen, Germany; Sigma Aldrich NV/SA, Kardinaal Cardijnplein 8, 2880 Bornem, Belgium; ProCepT nv, Rosteyne 4, 9060 Zelzate, Belgium; GEA Process Engineering Inc.•9165 Rumsey Road •Columbia, Md. 21045, US; Mettler-Toledo, Inc., 1900 Polaris Parkway, Columbus, Ohio, 43240, US; IKA-Werke GmbH & Co. KG, Janke & Kunkel Str. 10, 79219 Staufen, Germany; Alfa Aesar GmbH & Co KG, Zeppelinstrasse 7, 76185 Karlsruhe, Germany; Eastman Chemical Company, PO Box 431, Kingsport, Tenn. 37662, US; Glatt Ingenieurtechnik GmbH, Nordstrasse 12, 99427 Weimar, Germany; Tic Gums, White Marsh, Md. 21162, 10552 Philadelphia Rd, USA; CP Kelco B.V., Delta 1P, Business Park Ijsseloord 2, 6825 HL Arnhem, The Netherlands; Solvay Chimica Bussi, Via Marostica 1, 20146 Milano, Italy; Endecotts LTD, 9 Lombard Road, London, SW19 3TZ, United Kingdom; VWR International Eurolab S.L., C/ De la Tecnología, 5-17, A-7 Llinars Park, 08450 Llinars del Vallés, Spain, FRITSCH GmbH Telephone: 06784/70-153, Industriestrasse 8, 55743 Idar-Oberstein, Germany; Metrohm AG, Oberdorfstrasse 68, 9101 Herisau, Switzerland; Imes nv, Ekkelgaarden 26, 3500 Hasselt, Belgium; Gerhardt GmbH & Co., Caesariusstrasse 97, 52639 Koenigswinter, Germany; Kemira Chemicals, Inc., 1950 Vaughn Road, Kennesaw, Ga. 30144, United States; Cytec Industries Inc., 5 Garret Mountain Plaza, Woodland Park, N.J. 07424, United States; Irigeniatrics, Avd. Américo Vespucio 5-4, 1^{a} p., mód. 12, Sevilla; Spain; Harvard Apparatus, S.A.R.L, 6 Ave des Andes, Miniparc—Bat 8, 91952 Les Ulis Cedex, France.

### Process of Making Consumer Products

A process of making a consumer product comprising a consumer product adjunct material and a delivery particle is disclosed, said process may comprise:
a) preparing a first solution comprising, based on total solution weight, from about 0.1% to about 10% of a matrix binder that is suspended and/or dissolved in said first solution, and one or more solvents. In one aspect, such solvent may comprise water, ethanol, acetone, dichloromethane and mixtures thereof.
b) preparing a first composition comprising, based on total composition weight, from about 0.1% to about 30% of a matrix benefit agent that is suspended and/or dissolving in said first solution.
c) optionally, adding an external structuring system, based on total solution weight, from about 0.01% to about 2%, to said first composition. In one aspect, said matrix binder is able to provide structure to the system.
d) spraying said first composition in a chamber at a temperature of from about 25° C. to about 140° C. to form matrices containing a plurality of matrix benefit agent cores. In one aspect, said spraying process comprises a bi-fluid nozzle, a rotary disc, a high pressure nozzle, an electrified single needle or a flow focusing nozzle. In one aspect, said bi-fluid nozzle having a diameter from about 200 microns to about 3,500 microns, or from about 1,000 microns to about 3,000 microns. In one aspect, said flow focusing nozzle comprises a single flow focusing nozzle having a diameter from about 20 microns to about 700 microns, or from about 40 to about 500 microns, or even from about 100 microns to 350 microns. In one aspect, said rotary disc having a diameter from about 60 millimeters to about 350 millimeters. In one aspect, said electrified single needle having a diameter from about 100 microns to about 4,000 microns, or from about 250 to about 3,000, or even from about 500 microns to about 2,000 microns.
e) collecting said matrices.
f) preparing a second solution comprising, based on total solution weight, from about 1% to about 20% of a shell material that is suspended and/or dissolved in said second solution, and one or more solvents. In one aspect such solvent may comprise water, ethanol, acetone, dichloromethane and mixtures thereof.
g) optionally, adding a plasticizer, based on total solution weight, from about 0.01% to about 2%, to said second solution. Suitable plasticizers may comprise polyols such as sugars, sugar alcohols, or polyethylene glycols (PEGs), urea, glycol, propylene glycol or other known plasticizers such as triethyl citrate, dibutyl or dimethyl phthalate, polyethylene glycerin, sorbitol, tribuyl citrate, dibutyl sebecate and/or polysorbates.
h) preparing a third composition comprising, based on total composition weight, from about 1% to about 10% of said matrix particles that are suspended in said second solution or said third composition.
i) optionally, adding an external structuring system based on total solution weight, from about 0.01% to about 2%, to said third composition.
j) optionally, combining an anti-agglomeration agent with said third composition. Suitable anti-agglomeration agents may include fine insoluble and sparingly soluble material such as talc, TiO2, clays, amorphous silica, magnesium stearate, stearic acid and calcium carbonate.
k) spraying said second composition in a chamber at a temperature of from about 25° C. to about 140° C. to form a delivery particle. In one aspect, said spraying process comprises a bi-fluid nozzle, a rotary disc, a high pressure nozzle, an electrified single needle or a flow focusing nozzle. In one aspect, said bi-fluid nozzle having a diameter from about 200 microns to about 3,500 microns, or from about 1,000 microns to about 3,000 microns. In one aspect, said flow focusing nozzle comprises a single flow focusing nozzle having a diameter from about 20 microns to about 350 microns, or from about 40 to about 250 microns. In one aspect, said rotary disc having a diameter from about 60 millimeters to about 350 millimeters.
l) collecting said delivery particle. In one aspect, said electrified single needle having a diameter from about 100 microns to about 4,000 microns, or from about 250 to about 3,000, or even from about 500 microns to about 2,000 microns.
m) combining said delivery particle with one or more consumer product adjuncts, a deposition aid polymer or mixtures thereof.

In one aspect of said process of making a consumer product, said process may comprise:
a) preparing a first solution comprising, based on total solution weight, from about 0.1% to about 10% of a matrix binder that is suspended and/or dissolved in said first solution, and one or more solvents. In one aspect such solvent may comprise water, ethanol, acetone, dichloromethane and mixtures thereof.
b) preparing a first composition comprising, based on total composition weight, from about 0.1% to about 30% of a matrix benefit agent that is suspended and/or dissolved in said first solution.
c) optionally, adding an external structuring system, based on total solution weight, from about 0.01% to about 2%, to said third composition.
d) spraying said first composition in a chamber at a temperature of from about 25° C. to about 140° C. to form matrices containing a plurality of matrix benefit agent cores. In one aspect, said spraying process comprises a bi-fluid nozzle, a rotary disc, a high pressure nozzle, an electrified single needle or a flow focusing nozzle. In one aspect, said bi-fluid nozzle having a diameter from about 200 microns to about 3,500 microns, or from about 1,000 microns to about 3,000 microns. In one aspect, said flow focusing nozzle comprises a single flow focusing nozzle having a diameter from about 20 microns to about 1000 microns or from about 40 to about 700 microns, or even from about 100 microns to 350 microns. In one aspect, said rotary disc having a diameter from about 60 millimeters to about 350 millimeters. In one aspect, said electrified single needle having a diameter from about 100 microns to about 4,000 microns, or from about 250 to about 3,000, or even from about 500 microns to about 2,000 microns.
e) collecting said matrix particles.
f) preparing a second solution comprising, based on total solution weight, from about 1% to about 20% of a shell material that is suspended and/or dissolved in said second solution, and one or more solvents. In one aspect, such solvent may comprise water, ethanol, acetone, dichloromethane and mixtures thereof.
g) optionally, preparing a second composition comprising, based on total solution weight, from about 0.01% to about 2% of a plasticizer and said second solution. Suitable plasticizers may comprise polyols such as sugars, sugar alcohols, or polyethylene glycols (PEGs), urea, glycol, propylene glycol or other known plasticizers such as triethyl citrate, dibutyl or dimethyl phthalate, polyethylene glycerin, sorbitol, tribuyl citrate, dibutyl sebecate and/or polysorbates.
h) optionally, combining an anti-agglomeration agent with said second solution or second composition. Suitable anti-agglomeration agents may include fine insoluble and sparingly soluble material such as talc, TiO₂, clays, amorphous silica, magnesium stearate, stearic acid and calcium carbonate.
i) fluidizing said matrices in a spouted bed.
j) spraying said second solution or second composition on said matrix particles at a temperature of from about 25° C. to about 100° C. to form a delivery particle.
k) collecting said delivery particle.
l) combining said delivery particle with one or more consumer product adjuncts, a deposition aid polymer or mixtures thereof.

In one aspect of said of making a consumer product, said process may comprise:
a) preparing a first solution comprising, based on total solution weight, from about 0.1% to about 10% of a matrix binder that is suspended and/or dissolved in said first solution, and one or more solvents. In one aspect, such solvent may comprise water, ethanol, acetone, dichloromethane and mixtures thereof.
b) preparing a first composition comprising, based on total composition weight, from about 0.1% to about 30% of a matrix benefit agent that is suspended and/or dissolved in said first solution.
c) optionally, preparing a second composition comprising, based on total composition weight, from about 0.05 to 3% of an external structuring system and said first said composition.
d) preparing a second solution comprising, based on total solution weight, from about 1% to about 20% of a shell material that is suspended and/or dissolved in said second solution, and one or more solvents. In one aspect, such solvent may comprise water, ethanol, acetone, dichloromethane and mixtures thereof.
e) optionally, preparing a second composition comprising, based on total solution weight, from about 0.01% to about 2% of a plasticizer and said second solution. Suitable plasticizers may comprise polyols such as sugars, sugar alcohols, or polyethylene glycols (PEGs), urea, glycol, propylene glycol or other known plasticizers such as triethyl citrate, dibutyl or dimethyl phthalate, polyethylene glycerin, sorbitol, tribuyl citrate, dibutyl sebecate and/or polysorbates.
f) spraying said first or second composition and said second solution in a chamber at a temperature of from about 25° C. to about 140° C. by using a concentric nozzle or a electrified coaxial needle to form a delivery particle. In one aspect, said concentric nozzle comprises a flow focusing nozzle or a coaxial nozzle. In one aspect, said concentric flow focusing nozzle having a inner diameter of from about 20 to about 200, from about 45 to about 150, and an outer diameter of from about 40 to about 350, or from about 70 to about 250. In one aspect, said electrified coaxial needle having a diameter from about 100 microns to about 4,000 microns, or from about 250 to about 3,000, or even from about 500 microns to about 2,000 microns.
g) collecting said delivery particle.
h) combining said delivery particle with one or more consumer product adjuncts.

### Adjunct Materials

For the purposes of the present invention, the non-limiting list of adjuncts illustrated hereinafter are suitable for use in the instant compositions and may be desirably incorporated in certain embodiments of the invention, for example to assist or enhance performance, for treatment of the substrate to be cleaned, or to modify the aesthetics of the composition as is the case with perfumes, colorants, dyes or the like. It is understood that such adjuncts are in addition to the components supplied by the recited delivery particle. The precise nature of these additional components, and levels of incorporation thereof, will depend on the physical form of the composition and the nature of the operation for which it is to be used. Suitable adjunct materials include, but are not limited to, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, external structuring systems, fabric softeners, carriers, hydrotropes, processing aids and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

Each adjunct ingredient is not essential to Applicants' compositions. Thus, certain embodiments of Applicants' compositions do not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, external structuring system, fabric softeners, carriers, hydrotropes, processing aids and/or pigments. It is understood that such adjuncts may form a product matrix that is combined with the delivery particle disclosed herein to form a finished consumer product. Generally, when one or more adjuncts are present, such one or more adjuncts may be present as detailed below:

Surfactants—The compositions according to the present invention can comprise a surfactant or surfactant system wherein the surfactant can be selected from nonionic and/or anionic and/or cationic surfactants and/or ampholytic and/or zwitterionic and/or semi-polar nonionic surfactants. The surfactant is typically present at a level of from about 0.1%, from about 1%, or even from about 5% by weight of the cleaning compositions to about 99.9%, to about 80%, to about 35%, or even to about 30% by weight of the cleaning compositions.

Polymers—The compositions according to the present invention can comprise a polymeric dispersing agent, clay soil removal/anti-redeposition agent or mixtures thereof. In one aspect, said polymer system may comprise one or more amphiphilic alkoxylated greasy cleaning polymers, and either a clay soil cleaning polymer or a soil suspending polymer. Suitable polymer systems are described in patent US2009/0124528A1. The polymer system is typically present at a level of from about 0.1%, to about 5%, or even from about 0.3% to about 2%, or even better from about 0.6% to about 1.5% by weight of the cleaning compositions.

Builders—The compositions of the present invention can comprise one or more detergent builders or builder systems. When present, the compositions will typically comprise at least about 1% builder, or from about 5% or 10% to about 80%, 50%, or even 30% by weight, of said builder. Builders include, but are not limited to, the alkali metal, ammonium and alkanolammonium salts of polyphosphates, alkali metal silicates, alkaline earth and alkali metal carbonates, aluminosilicate builders polycarboxylate compounds, ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Chelating Agents—The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein.

Dye Transfer Inhibiting Agents—The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

Dispersants—The compositions of the present invention can also contain dispersants. Suitable water-soluble organic materials are the homo- or co-polymeric acids or their salts, in which the polycarboxylic acid may comprise at least two carboxyl radicals separated from each other by not more than two carbon atoms.

Enzymes—The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

Enzyme Stabilizers—Enzymes for use in compositions, for example, detergents can be stabilized by various techniques. The enzymes employed herein can be stabilized by the presence of water-soluble sources of calcium and/or magnesium ions in the finished compositions that provide such ions to the enzymes.

Catalytic Metal Complexes—Applicants' compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methyl-enephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. Nos. 5,597,936 and 5,595,967. Such cobalt catalysts are readily prepared by known procedures, such as taught for example in U.S. Pat. Nos. 5,597,936, and 5,595,967.

Compositions herein may also suitably include a transition metal complex of a macropolycyclic rigid ligand—abbreviated as “MRL”. As a practical matter, and not by way of limitation, the compositions and cleaning processes herein can be adjusted to provide on the order of at least one part per hundred million of the benefit agent MRL species in the aqueous washing medium, and may provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include manganese, iron and chromium. Suitable MRL's herein are a special type of ultra-rigid ligand that is cross-bridged such as 5,12-diethyl-1,5,8,12-tetraazabicyclo[6.6.2]hexa-decane.

Suitable transition metal MRLs are readily prepared by known procedures, such as taught for example in WO 00/32601, and U.S. Pat. No. 6,225,464.

External structuring system—The consumer product of the present invention may comprise from 0.01% to 5% or even from 0.1% to 1% by weight of an external structuring system. The external structuring system may be selected from the group consisting of:

(i) non-polymeric crystalline, hydroxy-functional structurants and/or

(ii) polymeric structurants

Such external structuring systems may be those which impart a sufficient yield stress or low shear viscosity to stabilize a fluid laundry detergent composition independently from, or extrinsic from, any structuring effect of the detersive surfactants of the composition. They may impart to a fluid laundry detergent composition a high shear viscosity at 20⁻¹ at 21° C. of from 1 cps to 1500 cps and a viscosity at low shear (0.05 s⁻¹ at 21° C.) of greater than 5000 cps. The viscosity is measured using an AR 550 rheometer from TA instruments using a plate steel spindle at 40 mm diameter and a gap size of 500 μm. The high shear viscosity at 20 s⁻¹ and low shear viscosity at 0.5 s⁻¹ can be obtained from a logarithmic shear rate sweep from 0.1 s⁻¹ to 25 s⁻¹ in 3 minutes time at 21° C. In one embodiment, the compositions may comprise from 0.01 to 1% by weight of a non-polymeric crystalline, hydroxyl functional structurant. Such non-polymeric crystalline, hydroxyl functional structurants may comprise a crystallizable glyceride which can be pre-emulsified to aid dispersion into the final unit dose laundry detergent composition. Suitable crystallizable glycerides include hydrogenated castor oil or “HCO” or derivatives thereof, provided that it is capable of crystallizing in the liquid detergent composition.

Unit dose laundry detergent compositions may comprise from 0.01 to 5% by weight of a naturally derived and/or synthetic polymeric structurant. Suitable naturally derived polymeric structurants include: hydroxyethyl cellulose, hydrophobically modified hydroxyethyl cellulose, carboxymethyl cellulose, polysaccharide derivatives and mixtures thereof. Suitable polysaccharide derivatives include: pectine, alginate, arabinogalactan (gum Arabic), carrageenan, gellan gum, xanthan gum, guar gum and mixtures thereof. Suitable synthetic polymeric structurants include: polycarboxylates, polyacrylates, hydrophobically modified ethoxylated urethanes, hydrophobically modified non-ionic polyols and mixtures thereof. In one aspect, the polycarboxylate polymer may be a polyacrylate, polymethacrylate or mixtures thereof. In another aspect, the polyacrylate may be a copolymer of unsaturated mono- or di-carbonic acid and C₁-C₃₀ alkyl ester of the (meth)acrylic acid. Such copolymers are available from Noveon inc under the tradename Carbopol® Aqua 30.

### Method of Use

Certain of the consumer products disclosed herein can be used to clean or treat a situs inter alia a surface or fabric. Typically at least a portion of the situs is contacted with an embodiment of Applicants'consumer product, in neat form or diluted in a liquor, for example, a wash liquor and then the situs may be optionally washed and/or rinsed. In one aspect, a situs is optionally washed and/or rinsed, contacted with an aspect of the consumer product and then optionally washed and/or rinsed. For purposes of the present invention, washing includes but is not limited to, scrubbing, and mechanical agitation. The fabric may comprise most any fabric capable of being laundered or treated in normal consumer use conditions. Liquors that may comprise the disclosed compositions may have a pH of from about 3 to about 11.5. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric ratio is typically from about 1:1 to about 30:1.

The employing one or more of the aforementioned methods result in a treated situs.

### Test Methods

It is understood that the test methods that are disclosed in the Test Methods Section of the present application should be used to determine the respective values of the parameters of Applicants' invention as such invention is described and claimed herein.

### (1) Mean Particle Size for Slurries/Liquids Containing Delivery Particles in the Range of 1 to 500 Microns

The mean particle size of the delivery particles is determined using a Lasentec M500L-3,6-K supplied by Mettler-Toledo, Inc., 1900 Polaris Parkway, Columbus, Ohio, 43240, US. The equipment is setup (Lasentec, FBRM Control Interface, version 6.0) as described in the Lasentec manual, issued February 2000. Software setup and sample analysis is performed using Windows software (Windows XP, version 2002) in the WINDOWS manual. When the particles are collected as solid delivery particles, in order to perform the test, such particles are uniformly dispersed in deionized water.

### (2) Benefit Agent Release Test

### Materials and Instruments Needed:

1. launder-o-meter (launder-o-meter procedures are described in the Technical Manual of the AATCC)
2. Test pieces of soiled fabric 10×10 cm as described in JAOCS, Vol. 66, n.1 (January 1989)
3. A canister of 50 steel balls of 6 mm diameter
4. Industrial water (2.5 mmol/L hardness)
5. Detergent composition containing delivery particles having a matrix comprising a plurality of matrix benefit agent cores.

### Procedure:

Prepare a stainless-steel launder-o-meter container and add 250 mL of water at 30° C., 2.5 g of a liquid detergent composition containing delivery particles containing a plurality of matrix benefit agent cores, three test pieces of soiled fabric 10×10 cm and 50 steel balls. Containers are place in the launder-ometer and they are rotated for 40 minutes at 42 rpm. Every 5 minutes a sample is taken for analytical measurement of the benefit agent. The analysis is performed in accordance with the applicable protocol that is listed below:

A. Analytical test for preformed peracids, bleach activators and hydrogen peroxide sources:

Hydrogen peroxide in liquid bleaches liberates iodine from an acidified potassium iodide solution. The free iodine is titrated potentiometrically with a standardized thiosulphate solution

Bleach component+2I⁻+2H⁺→I₂+2H₂O [1]

I₂+I⁻ [symbol] I₃⁻ [2]

I₃⁻+2S₂O₃2⁻→3I⁻+S₄O₆ [3]

The bleach component can be a hydrogen peroxide source, a preformed peracid or a peracid generated by a bleach activator. The method measures the total amount of bleach. In case the bleach is generated from a bleach activator reacting with hydrogen peroxide, Catalase needs to be added after the peracid generation. Catalase destroys hydrogen peroxide without influencing the peracid and only the peracid is present for further analysis.

Equipment:
Autotitrator (fe Metrohm 809) connected to a computer
Redox electrode (fe Metrohm 6.0431.100)

Chemicals:
Glacial Acetic Acid (VWR 1.00063)
KI 3 M (Sigma Aldrich 35175)
Na₂S₂O₃ 0.01N (38243, Sigma Aldrich)
Catalase from bovine lever Fluka Biochemica 60640±260000 U/mL
Sodium percarbonate 10% aqueous solution. In order to prepare this solution, add 100 grams sodium carbonate (VWR ALFAA16045) to 900 mL deionized water under continuous stirring.

Procedure:
1. Hydrogen peroxide sources and preformed peracids in absence of additional hydrogen peroxide:
   a. weigh x grams of sample in order to have between 0.05 and 1 grams of benefit agent.
   b. Add 50 mL water
   c. Add 10 mL of acetic acid.
   d. Stir for 1 minute
   e. Add 4 mL of KI solution
   f. Titrate with Na₂S₂O₃ with the redox electrode until the first equivalent point
   g. Calculate the release index of peroxide/peracid:

$$Release index = \frac{V \cdot N \cdot {M}_{w}}{G \cdot 2000}$$

wherein V is the measured volume in mL, N is the normality of the sodium thiosulfate solution, Mw the molecular weight of the preformed peracid or the hydrogen peroxide source and G the grams, based on 100% purity, of the preformed peracid or the hydrogen peroxide source weight for the titration.
2. In situ formed peracids (in situ reaction of hydrogen peroxide and a bleach activator)
   a. Weigh x grams of sample in order to have between 0.05 and 1 grams of benefit agent.
   b. Add 50 mL of percarbonate solution
   c. Stir for 10 minutes (to enable peracid formation)
   d. Add 0.5 mL of Catalase
   e. Stir for at least 1 minute (maximum 5 minutes)
   f. Add 10 mL of acetic acid
   g. Add 4 mL KI solution
   h. Titrate with Na₂S₂O₃ with the redox electrode until the first equivalent point
   i. Calculate the release index of peracid:

$$Release index = \frac{V \cdot N \cdot {M}_{w}}{G \cdot 2000}$$

wherein V is the measured volume in mL, N is the normality of the sodium thiosulfate solution, Mw the molecular weight of the bleach activator and G the grams, based on 100% purity, of the bleach activator weight for the titration.
   B. Analytical test for metal catalysts: Photometric method

The activity of the bleach catalyst is measured by means of a colorimetric reaction with a specific dye.
a. Preparation of a calibration curve: Add 40 μL of a 10,000 ppm detergent solution like the ones described in examples 4, 5 and 6, without particles containing X ppm of the metal catalyst in deionized water to 150 μL of Chicago sky blue reagent and incubate at 37° C. for 3 minutes (see table below). After incubation an absorbance measure of the solution of detergent and dye is made at 600 nm (Abs 1). Add 60 μL of the hydrogen peroxide reagent to the solution and incubate at 37° C. for 30 minutes. Measure the absorbance of this solution at 600 nm after incubation (Abs 2). Repeat this with different levels of metal catalyst according to following table:

TABLE 2
Data for calibration curve

| | X ppm metal | | | |
|---|---|---|---|---|
| Sample | catalyst | Abs 1 | Abs 2 | ABS = Abs 1 − Abs 2 |
| 0 | 0 | | | |
| 1 | 0.05 | | | |
| 2 | 0.10 | | | |
| 3 | 0.20 | | | |
| 4 | 0.30 | | | |
| 5 | 0.40 | | | |
| 6 | 0.50 | | | |
| 7 | 0.60 | | | |
| 8 | 0.80 | | | |
| 9 | 1.00 | | | |
| 10 | 1.25 | | | |
| 11 | 1.50 | | | |
| 12 | 1.75 | | | |
| 13 | 2.00 | | | |
| 14 | 2.50 | | | |
| 15 | 3.00 | | | |

Subtract the initial measured absorbance (Abs 1) from the final (Abs 2) and plot a calibration curve (polynomial fit).
b. Measure 40 μL of the sampled wash solution and determine the concentration of metal catalyst in the wash by using the calibration curve.
c. Determine the release index:

$$Release index = \frac{{C}_{wash}}{{C}_{total}}$$

wherein C_{wash} is the concentration determined in the wash in ppm and Cₜₒₜₐₗ is the total amount of metal catalyst in the wash in ppm (total encapsulated).
   C. Analytical test for bleach boosters: Isoquinolinium class materials and the activated intermediate can be measured by mass spectrometry. Depending upon the response of the individual molecule, electrospray mass spectrometry operated in positive or negative ion is used to measure the isoquinolinium and the oxidized intermediate. MS analysis is done either by direct infusion or by injecting discrete amounts of diluted sample (flow injection analysis). No HPLC separation is needed.
a. Eluents: acetonitrile:water (1/1)+1 mmol ammonium acetate.
b. Instrument settings are optimized for individual molecules to obtain maximum response.
c. Subsequent measurements are done either in selective ion mode or multiple reaction monitoring.
d. Samples are diluted in acetonitrile/water 1/1+1 mmol ammonium acetate. Dilution factor depends upon concentration of the isoquinolinium.
e. MS setup: electrospray in either positive or negative ion mode. When full scan acquisition is desired, both scan modes are alternated for full scan acquisition.
   Release index is calculated using the same formula as described above for metal catalysts.
   D. Analytical test for diacyl peroxides: Diacyl peroxides are measured by means of HPLC separation followed by electrochemical detection. A short chain RP column is used for the separation, 5 μm, 250 mm*4.6 mm A typical eluent is water/acetonitrile (250 mL/850 mL) with 0.0025 M ammonium dihydrogen phosphate. The flow rate is set up to 1.0 mL/min and the detection is done by DC amperometry or colorimetry. Samples are diluted in a mixture of acetonitrile and acetic acid glacial in a ratio of 90% acetonitrile and 10% acetic acid glacial prior to analysis. Release index is calculated using the same formula as described above for metal catalysts
   E. Enzyme release index may be measured using ASTM method D0348-89 (2003).

### (3) Stability Index Determination of Benefit Agent on Storage

The amount of matrix benefit agent left upon storage of delivery particles containing these matrix benefit agent cores in a laundry detergent composition, can be determined filtering the delivery particles from the liquid detergent composition, breaking said delivery particles to release the matrix benefit agent and analyzing the amount of matrix benefit agent left upon storage by using standard analytical methods as described below.

Conditions stability test: samples containing 1% of matrix benefit agent in delivery particle form are stored 7 days at 30° C. in a laundry detergent composition.
Filtration: After 7 days at 30° C. samples are filtered using an 8 microns filter (Whatman Int. LTD, supplied by VWR). Delivery particles are rinsed twice with 3 mL of water.
Delivery particles breakage for matrix benefit agent release: Filter paper containing the aged delivery particles is introduced in a 250 mL glass pot and 100 mL of deionized water is added. A metal ball of 4 cm diameter (Imes, Belgium) is introduced in the glass pot and the glass pot is closed. The mixture containing the particles is kept at 45° C. for 1 hour in a thermo shaker at 135 rpm (Thermo shaker THO 5, Gerhardt) for complete matrix benefit agent release.
Stability index determination: Matrix benefit agent is analyzed according analytical methods described below.
A. Analytical test for preformed peracids, bleach activators and hydrogen peroxide sources:

Hydrogen peroxide in liquid bleaches liberates iodine from an acidified potassium iodide solution. The free iodine is titrated potentiometrically with a standardized thiosulphate solution

Bleach component+2I⁻+2H⁺→I₂+2H₂O [1]

I₂+I⁻ [symbol] I₃⁻ [2]

I₃⁻+2S₂O₃2⁻→3I⁻+S₄O₆ [3]

The bleach component can be a hydrogen peroxide source, a preformed peracid or a peracid generated by a bleach activator. The method measures the total amount of bleach. In case the bleach is generated from a bleach activator reacting with hydrogen peroxide, Catalase needs to be added after the peracid generation. Catalase destroys hydrogen peroxide without influencing the peracid and only the peracid is present for further analysis.

Equipment:
Autotitrator (fe Metrohm 809) connected to a PC
Redox electrode (fe Metrohm 6.0431.100)

Chemicals:
Glacial Acetic Acid (VWR 1.00063)
KI 3 M (Sigma Aldrich 35175)
Na₂S₂O₃ 0.1N (VWR 1.09147)
Catalase from bovine lever Fluka Biochemica 60640±260000 U/mL
Sodium percarbonate 10% aqueous solution. In order to prepare this solution, add 100 grams sodium carbonate (VWR ALFAA16045) to 900 mL deionized water under continuous stirring.

Procedure:
3. Hydrogen peroxide sources and preformed peracids in absence of additional hydrogen peroxide:
   a. weigh x grams of sample (broken aged delivery particles) in order to have between 0.5 and 1 grams of benefit agent.
   b. Add 50 mL water
   c. Add 10 mL of acetic acid.
   d. Stir for 1 minute
   e. Add 4 mL of KI solution
   f. Titrate with Na₂S₂O₃ with the redox electrode until the first equivalent point
   g. Calculate the stability index of peroxide/peracid:

$$stability index = \frac{V \cdot N \cdot {M}_{w}}{G \cdot 2000}$$

wherein V is the measured volume in mL, N is the normality of the sodium thiosulfate solution, Mw the molecular weight of the preformed peracid or the hydrogen peroxide source and G the grams, based on 100% purity, of the preformed peracid or the hydrogen peroxide source weight for the titration.
4. In situ formed peracids (in situ reaction of hydrogen peroxide and a bleach activator)
   a. Weigh x grams of sample (broken aged delivery particles) in order to have between 0.5 and 1 grams of benefit agent.
   b. Add 50 mL of percarbonate solution
   c. Stir for 10 minutes (to enable peracid formation)
   d. Add 0.5 mL of Catalase
   e. Stir for at least 1 minute (maximum 5 minutes)
   f. Add 10 mL of acetic acid
   g. Add 4 mL KI solution
   h. Titrate with Na₂S₂O₃ with the redox electrode until the first equivalent point
   i. Calculate the stability index of peracid:

$$Stability index = \frac{V \cdot N \cdot {M}_{w}}{G \cdot 2000}$$

wherein V is the measured volume in mL, N is the normality of the sodium thiosulfate solution, Mw the molecular weight of the bleach activator and G the grams, based on 100% purity, of the bleach activator weight for the titration.
   B. Analytical test for metal catalysts: Photometric method

The activity of the bleach catalyst is measured by means of a colorimetric reaction with a specific dye.
a. Preparation of a calibration curve: Add 40 μL of a 10.000 ppm detergent solution like the ones described in examples 4, 5 and 6, without delivery particles containing X ppm of the metal catalyst in deionized water to 150 μL of Chicago sky blue reagent and incubate at 37° C. for 3 minutes (see table below). After incubation an absorbance measure of the solution of detergent and dye is made at 600 nm (Abs 1). Add 60 μL of the hydrogen peroxide reagent to the solution and incubate at 37° C. for 30 minutes. Measure the absorbance of this solution at 600 nm after incubation (Abs 2). Repeat this with different levels of metal catalyst according to following table:

TABLE 3
Data for calibration curve

| | X ppm metal | | | |
|---|---|---|---|---|
| Sample | catalyst | Abs 1 | Abs 2 | ABS = Abs 1 − Abs 2 |
| 0 | 0 | | | |
| 1 | 0.05 | | | |
| 2 | 0.10 | | | |
| 3 | 0.20 | | | |
| 4 | 0.30 | | | |
| 5 | 0.40 | | | |
| 6 | 0.50 | | | |
| 7 | 0.60 | | | |
| 8 | 0.80 | | | |
| 9 | 1.00 | | | |
| 10 | 1.25 | | | |
| 11 | 1.50 | | | |
| 12 | 1.75 | | | |
| 13 | 2.00 | | | |
| 14 | 2.50 | | | |
| 15 | 3.00 | | | |

Subtract the initial measured absorbance (Abs 1) from the final (Abs 2) and plot a calibration curve (polynomial fit).

b. Measure 40 μL of the broken aged delivery particles and determine the concentration of metal catalyst in the wash by using the calibration curve.
c. Determine the stability index:

$$Stability index = \frac{{C}_{aged particles}}{{C}_{total}}$$

wherein C_{aged particles} is the concentration of metal catalyst determined inside the particles after storage in the liquid detergent composition in ppm and Cₜₒₜₐₗ is the total amount of metal catalyst in the liquid detergent composition in ppm (total encapsulated).
   C. Analytical test for bleach boosters: Isoquinolinium class materials and the activated intermediate can be measured by mass spectrometry. Depending upon the response of the individual molecule, electrospray mass spectrometry operated in positive or negative ion is used to measure the isoquinolinium and the oxidized intermediate. MS analysis is done either by direct infusion or by injecting discrete amounts of diluted sample (flow injection analysis). No HPLC separation is needed.
a. Eluens: acetonitrile:water (1/1)+1 mmol ammonium acetate.
b. Instrument settings are optimized for individual molecules to obtain maximum response.
c. Subsequent measurements are done either in selective ion mode or multiple reaction monitoring.
d. Samples are diluted in acetonitrile/water 1/1+1 mmol ammonium acetate. Dilution factor depends upon concentration of the isoquinolinium.
e. MS setup: electrospray in either positive or negative ion mode. When full scan acquisition is desired, both scan modes are alternated for full scan acquisition.
   Stability index is calculated using the same formula as described above for metal catalysts.
   D. Analytical test for diacyl peroxides: Diacyl peroxides are measured by means of HPLC separation followed by electrochemical detection. A short chain RP column is used for the separation, 5 μm, 250 mm*4.6 mm A typical eluent is water/acetonitrile (250 mL/850 mL) with 0.0025M ammonium dihydrogen phosphate. The flow rate is set up to 1.0 mL/min and the detection is done by DC amperometry or colorimetry. Samples are diluted in a mixture of acetonitrile and acetic acid glacial in a ratio of 90% acetonitrile and 10% acetic acid glacial prior to analysis. Stability index is calculated using the same formula as described above for metal catalysts
   E. Enzyme stability index may be measured using ASTM method D0348-89 (2003).

### (4) Centrifuge Retention Capacity (CRC) Test Method

Centrifuge retention capacity may be measured using test method EDANA 441.2-02

### (5) pH Measurement of a Liquid Detergent Composition

pH measurement of a liquid detergent composition may be measured using test method EN 1262.

### (6) Average Molecular Mass

For purposes of the present specification and claims, the average molecular mass of a polymer is determined in accordance with ASTM Method ASTM D4001-93 (2006).

### (7) Hydrolysis Degree

For purposes of the present specification and claims, hydrolysis degree is determined in accordance with the method found in U.S. Pat. No. 6,132,558, column 2, line 36 to column 5, line 25.

### (8) Charge Density

For purposes of the present specification and claims, the charge density of a polymer is determined with the aid of colloid titration, cf. D. Horn, Progress in Colloid & Polymer Sci. 65 (1978), 251-264.

### EXAMPLES

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 1

### Production of Delivery Particles Using Flow Focusing Technology

1000 grams of a 0.5% solution of Xanthan Gum (Kelzan ASX-T, CPKelco) in demi-water is prepared at 60 C. This solution is cooled to room temperature and mixed with an amount of PAP EURECO LX17, previously filtered with a 20 microns sieve, such as the total amount of PAP in filtered sample is 170 grams, to form a first suspension. This first suspension is stirred for 10 min at 700 rpm. A second solution comprising 1500 grams of an 8% Polyvinyl acetate (MW˜167,000 g/mol, Sigma Aldrich) solution in acetone:water 20:80 solution is prepared. Then, the first suspension and the second solution is introduced in the spray-drier (Niro GmbH, Gemany) under constant stirring, separately, by using two high pressure syringe pumps (PHD 4400, Harvard, France), using a concentric flow focusing nozzle (Ingeniatrics, Spain). Particles containing 57% PAP are collected and used in consumer products described in following examples.

### Example 2

### Production of Spray Dried Delivery Particles

1000 grams of a 0.5% solution of Xanthan Gum (Kelzan ASX-T, CPKelco) in demi-water is prepared at 60° C. This solution is cooled to room temperature and mixed with an amount of PAP EURECO LX17, previously filtered with a 20 microns sieve, such as the total amount of PAP in filtered sample is 170 grams, to form a suspension. This suspension is stirred for 10 min at 700 rpm and then introduced in the spray-drier (Niro GmbH, Gemany) under constant stifling at 300 rpm using a peristaltic pump (Watson-Marlow, Mass., US). Solid particles are collected. Then, 100 grams of these collected particles are suspended in 1500 grams of a 10% Polyvinyl alcohol (M_{w} average≈13,000-26,000, ref. 363170, Sigma-Aldrich) solution in demi-water. This suspension is stirred for 5 minutes at 700 rpm and then introduced in the spray-drier (Niro GmbH, Gemany) under constant stifling at 300 rpm using a peristaltic pump (Watson-Marlow, Mass., US). Particles containing 47% PAP are collected and used in consumer products described in following examples.

### Examples 3, 4 and 5

### Liquid Detergent Composition

Non-limiting examples of product formulations containing an encapsulated matrix benefit agent summarized in the following table

| | Example 3 | Example 4 | Example 5 |
|---|---|---|---|
| Dosage | 40 mL | 35 mL | 31 mL |
| Ingredients | Weight % | | |
| C₁₁₋₁₆ Alkylbenzene | 20.0 | 12.5 | 22.0 |
| sulfonic acid | | | |
| C₁₂₋₁₄ Alkyl sulfate | | 2.0 | |
| C₁₂₋₁₄ alkyl | 17.0 | 17.0 | 19.0 |
| 7-ethoxylate | | | |
| C₁₂₋₁₄ alkyl ethoxy | 7.5 | | 8.0 |
| 3 sulfate | | | |
| Citric acid | 0.9 | 1.0 | 2.0 |
| C₁₂₋₁₈ Fatty acid | 13.0 | 18.0 | 18.0 |
| Sodium citrate | | 4.0 | |
| enzymes | 0-3.0 | 0-3.0 | 0-3.0 |
| Ethoxylated | 2.2 | | |
| Polyethylenimine¹ | | | |
| Hydroxyethane | 0.6 | 0.5 | 2.2 |
| diphosphonic acid | | | |
| Amphiphilic | 2.5 | | 3.5 |
| alkoxylated grease | | | |
| cleaning polymer² | | | |
| Ethylene diamine | | | 0.4 |
| tetra(methylene | | | |
| phosphonic) acid | | | |
| Brightener | 0.2 | 0.3 | 0.3 |
| Perfume | 0.4 | | |
| microcapsules⁴ | | | |
| Particles (47% PAP)³ | 1.5 | 2.3 | 1.7 |
| Water | 9 | 5 | 10 |
| CaCl2 | | | 0.01 |
| Perfume | 1.7 | 0.6 | 1.6 |
| Hydrogenated castor | 0.4 | 0.3 | 0.3 |
| oil | | | |
| Minors (antioxidant, | 2.0 | 4.0 | 2.3 |
| sulfite, aesthetics, . . .) | | | |

| | |
|---|---|
| Buffers | To pH 8.0 |
| (monoethanolamine) | |
| Solvents (1,2 | To 100 parts |
| propanediol, ethanol) | |

¹Polyethylenimine (MW = 600) with 20 ethoxylate groups per —NH.
²PG617 or PG640 (BASF, Germany)
³coated particles as described in example 2.
⁴Perfume microcapsules can be prepared as follows: 25 grams of butyl acrylate-acrylic acid copolymer emulsifier (Colloid C351, 25% solids, pka 4.5-4.7, (Kemira Chemicals, Inc. Kennesaw, Georgia U.S.A.) is dissolved and mixed in 200 grams deionized water. The pH of the solution is adjusted to pH of 4.0 with sodium hydroxide solution. 8 grams of partially methylated methylol melamine resin (Cymel 385, 80% solids, (Cytec Industries West Paterson, New Jersey, U.S.A.)) is added to the emulsifier solution. 200 grams of perfume oil is added to the previous mixture under mechanical agitation and the temperature is raised to 50° C.. After mixing at higher speed until a stable emulsion is obtained, the second solution and 4 grams of sodium sulfate salt are added to the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.8, 25 grams of partially methylated methylol melamine resin (Cymel 385, 80% solids, Cytec). This mixture is heated to 70° C. and maintained overnight with continuous stirring to complete the encapsulation process. 23 grams of acetoacetamide (Sigma-Aldrich, Saint Louis, Missouri, U.S.A.) is added to the suspension.

### Examples 6, 7 and 8

### Unit Dose Composition

Compositions from examples 3, 4 and 5 are enclosed within a PVA film. In one aspect, the film used in the present examples is Monosol M8630 76 μm thickness.

### Examples 9 and 10

### Unit Dose Composition

The following are examples of unit dose executions wherein the liquid composition is enclosed within a PVA film. In one aspect, the film used in the present examples is Monosol M8630 76 μm thickness.

| | Example 9 | | | Example 10 | | |
|---|---|---|---|---|---|---|
| Compartment | 1 | 2 | 3 | 4 | 5 | 6 |
| Dosage | 34.0 | 3.5 | 3.5 | 25.0 | 1.5 | 4.0 |
| Ingredients | Weight % | | | | | |
| C₁₁₋₁₆ Alkylbenzene | 20.0 | 20.0 | 20.0 | 20.0 | 25.0 | 30.0 |
| sulfonic acid | | | | | | |
| C₁₂₋₁₄ alkyl 7- | 17.0 | 17.0 | 17.0 | 17.0 | 15.0 | 10.0 |
| ethoxylate | | | | | | |
| C₁₂₋₁₄ alkyl ethoxy 3 | 7.5 | 7.5 | 7.5 | 7.5 | 7.5 | |
| sulfate | | | | | | |
| Citric acid | 0.5 | | 2.0 | | | 2.0 |
| C₁₂₋₁₈ Fatty acid | 13.0 | 13.0 | 13.0 | 18.0 | 10.0 | 15.0 |
| enzymes | 0-3.0 | 0-3.0 | 0-3.0 | 0-3.0 | | |
| Ethoxylated | 2.2 | 2.2 | 2.2 | | | |
| Polyethylenimine¹ | | | | | | |
| Hydroxyethane | 0.6 | 0.6 | 0.6 | | 2.2 | |
| diphosphonic acid | | | | | | |
| Ethylene diamine | | | | 0.4 | | |
| tetra(methylene | | | | | | |
| phosphonic) acid | | | | | | |
| Amphiphilic | 3.5 | | | 2.5 | | |
| alkoxylated grease | | | | | | |
| cleaning polymer | | | | | | |
| Brightener | 0.2 | 0.2 | 0.2 | 0.3 | | |
| Perfume | 0.4 | | | | | |
| microcapsules | | | | | | |
| Particles (57% PAP)³ | 1.9 | | | | 4.0 | 4.0 |
| Water | 9 | 8.5 | 10.0 | 10.0 | 10.0 | 9 |
| CaCl2 | | | | | 0.01 | |
| Perfume | 1.7 | 1.7 | | 1.5 | 0.5 | |
| Hydrogenated castor | 0.4 | | 0.1 | | 0.3 | 0.3 |
| oil | | | | | | |
| Minors (antioxidant, | 2.0 | 2.0 | 2.0 | 2.2 | 2.2 | 2.0 |
| sulfite, aesthetics, . . . ) | | | | | | |

| | |
|---|---|
| Buffers | To pH 8 |
| (monoethanolamine) | |
| Solvents (1,2 | To 100 parts |
| propanediol, ethanol) | |

¹Polyethylenimine (MW = 600) with 20 ethoxylate groups per —NH.
²PG617 or PG640 (BASF, Germany)
³coated particles as described in example 1.
⁴Perfume microcapsules preparation is described in examples 3, 4 and 5.

### Examples 11 and 12

### Liquid Detergent Composition

Non-limiting examples of product formulations containing an encapsulated matrix benefit agent summarized in the following table

| | | |
|---|---|---|
| | Example 11 | Example 12 |
| Dosage | 25 mL | 25 mL |

| | |
|---|---|
| Ingredients | Weight % |

| | | |
|---|---|---|
| Monoethanolamine: | 37.0 | 35.0 |
| C₁₂₋₁₅ EO•3•SO₃H | | |
| Monoethanolamine: | 5.9 | 6.0 |
| C₁₆₋₁₇ highly soluble | | |
| alkyl sulfate | | |
| C₁₂₋₁₄ dimethylamine- | 1.7 | 1.7 |
| N-oxide | | |
| Ethoxylated | 3.9 | 4.0 |
| Polyethyleneimine¹ | | |
| Citric acid | | 2.0 |
| Amphiphilic | 3.9 | 2.5 |
| alkoxylated grease | | |
| cleaning polymer² | | |
| C₁₂₋₁₈ Fatty acid | 3.0 | |
| Suds suppression | 0.1 | 0.1 |
| polymer | | |
| C₁₁₋₈ HLAS | 13.4 | 10.0 |
| HEDP | | 1.0 |
| Tiron | 2.0 | |
| Brightener | 0.1 | 0.2 |
| Perfume | 2.3 | |
| microcapsules⁴ | | |
| Particles (57% PAP)³ | 3.6 | 5.6 |
| Water | 4.7 | 5.0 |
| Perfume | 1.5 | 1.7 |
| External structuring | 0.4 | 0.2 |
| system | | |
| Minors (antioxidant, | 1.5 | 1.5 |
| sulfite, aesthetics, . . .) | | |

| | |
|---|---|
| Buffers | To pH 8.0 |
| (monoethanolamine) | |
| Solvents (1,2 | To 100 parts |
| propanediol, ethanol) | |

¹Polyethyleneimine (MW = 600 grams/mol) with 20 ethoxylate groups per —NH (BASF, Germany)
²PG617 or PG640 (BASF, Germany)
³coated particles as described in example 1.
⁴Perfume microcapsules preparation is described in examples 3, 4 and 5.

### Examples 13 and 14

### Unit Dose Composition

The following are examples of unit dose executions wherein the liquid composition is enclosed within a PVA film. In one aspect, the film used in the present examples is Monosol M8630 76 μm thickness.

| | Example 13 | | | Example 14 | | |
|---|---|---|---|---|---|---|
| Compartment | 7 | 8* | 9* | 10 | 11 | 12* |
| Dosage | 34.0 | 3.5 | 3.5 | 25.0 | 1.5 | 4.0 |
| Ingredients | Weight % | | | | | |
| C₁₁₋₁₆ Alkylbenzene | 20.0 | | | 20.0 | | |
| sulfonic acid | | | | | | |
| C₁₂₋₁₄ alkyl 7- | 17.0 | | | 17.0 | | |
| ethoxylate | | | | | | |
| C₁₂₋₁₄ alkyl ethoxy 3 | 7.5 | | | 7.5 | | |
| sulfate | | | | | | |
| Citric acid | 2.0 | | | | | |
| C₁₂₋₁₈ Fatty acid | 13.0 | | | 18.0 | | |
| enzymes | 0-3.0 | | | 0-3.0 | | |
| Ethoxylated | 2.2 | | | | | |
| Polyethylenimine¹ | | | | | | |
| Hydroxyethane | 0.6 | | | | | |
| diphosphonic acid | | | | | | |
| Amphiphilic | 2.3 | | | | | |
| alkoxylated grease | | | | | | |
| cleaning polymer² | | | | | | |
| Ethylene diamine | | | | 0.4 | | |
| tetra(methylene | | | | | | |
| phosphonic) acid | | | | | | |
| Brightener | 0.2 | | | | 1.5 | |
| Perfume | 0.4 | | | | | |
| microcapsules⁴ | | | | | | |
| Particles (47% PAP)³ | 1.9 | 100 | 100 | | | 100 |
| Water | 9 | | | 10.0 | | |
| CaCl2 | | | | | | |
| Perfume | 1.7 | | | 1.5 | | |
| Hydrogenated castor | 0.4 | | | | | |
| oil | | | | | | |
| Minors (antioxidant, | 2.0 | | | 2.2 | | |
| sulfite, aesthetics, . . . ) | | | | | | |

| | |
|---|---|
| Buffers | To pH 8 |
| (monoethanolamine) | |
| Solvents (1,2 | To 100 parts |
| propanediol, ethanol, | |
| glycerol) | |

¹Polyethyleneimine (MW = 600 grams/mol) with 20 ethoxylate groups per —NH (BASF, Germany)
²PG617 or PG640 (BASF, Germany)
³coated particles as described in Example 2.
⁴Perfume microcapsules preparation is described in Examples 3, 4 and 5.
*no pH adjustment and no solvents are added to these compartments

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A delivery particle comprising a shell material and one or more matrices, said shell encapsulating or embedding said one or more matrices, said one or more matrices comprising one or more matrix binders and a plurality of matrix benefit agent cores, said matrix benefit agent cores being dispersed in said one or more matrix binders, said delivery particle having a mean particle size distribution of from about 10 microns to about 350 microns.

2. The delivery particle of claim 1, wherein:
a) said matrix binder comprises a material selected from the group consisting of a water soluble and/or water dispersible non-reducing polysaccharide, a water soluble and/or water dispersible acrylate derivative and mixtures thereof;
b) said shell material comprises a material selected from the group consisting of polyvinyl alcohol, polyvinyl acetate, cellulose acetate, poly(vinyl-alcohol-co-vinylacetate), acrylic acid-ethylene-vinyl acetate copolymer and mixtures thereof; and
c) said matrix benefit agent comprises a material selected from the group consisting of a preformed peracid, a metal catalyst, a bleach activator, a bleach booster, a diacyl peroxide, a hydrogen peroxide source and an enzyme.

3. The delivery particle of claim 2 wherein:
a) said metal catalyst comprises a material selected from the group consisting of dichloro-1,4-diethyl-1,4,8,11-tetraaazabicyclo[6.6.2]hexadecane manganese(II); dichloro-1,4-dimethyl-1,4,8,11-tetraaazabicyclo[6.6.2]hexadecane manganese(II) and mixtures thereof;
b) said bleach booster comprises a material selected from the group consisting of 2-[3-[(2-hexyldodecyl)oxy]-2-(sulfooxy)propyl]-3,4-dihydroisoquinolinium, inner salt; 3,4-dihydro-2-[3-[(2-pentylundecyl)oxy]-2-(sulfooxy)propyl]isoquinolinium, inner salt; 2-[3-[(2-butyldecyl)oxy]-2-(sulfooxy)propyl]-3,4-dihydroisoquinolinium, inner salt; 3,4-dihydro-2-[3-(octadecyloxy)-2-(sulfooxy)propyl]isoquinolinium, inner salt; 2-[3-(hexadecyloxy)-2-(sulfooxy)propyl]-3,4-dihydroisoquinolinium, inner salt; 3,4-dihydro-2-[2-(sulfooxy)-3-(tetradecyloxy)propyl]isoquinolinium, inner salt; 2-[3-(dodecyloxy)-2-(sulfooxy)propyl]-3,4-dihydroisoquinolinium, inner salt; 2-[3-[(3-hexyldecyl)oxy]-2-(sulfooxy)propyl]-3,4-dihydroisoquinolinium, inner salt; 3,4-dihydro-2-[3-[(2-pentylnonyl)oxy]-2-(sulfooxy)propyl]isoquinolinium, inner salt; 3,4-dihydro-2-[3-[(2-propylheptyl)oxy]-2-(sulfooxy)propyl]isoquinolinium, inner salt; 2-[3-[(2-butyloctyl)oxy]-2-(sulfooxy)propyl]-3,4-dihydroisoquinolinium, inner salt; 2-[3-(decyloxy)-2-(sulfooxy)propyl]-3,4-dihydroisoquinolinium, inner salt; 3,4-dihydro-2-[3-(octyloxy)-2-(sulfooxy)propyl]isoquinolinium, inner salt; 2-[3-[(2-ethylhexyl)oxy]-2-(sulfooxy)propyl]-3,4-dihydroisoquinolinium, inner salt and mixtures thereof;
c) said bleach activator comprises a material selected from the group consisting of tetraacetyl ethylene diamine (TAED); benzoylcaprolactam (BzCL); 4-nitrobenzoylcaprolactam; 3-chlorobenzoylcaprolactam; benzoyloxybenzenesulphonate (BOBS); nonanoyloxybenzenesulphonate (NOBS); phenyl benzoate (PhBz); decanoyloxybenzenesulphonate (C₁₀-OBS); benzoylvalerolactam (BZVL); octanoyloxybenzenesulphonate (C₈-OBS); perhydrolyzable esters; 4-[N-(nonaoyl)amino hexanoyloxy]-benzene sulfonate sodium salt (NACA-OBS); dodecanoyloxybenzenesulphonate (LOBS or C₁₂-OBS); 10-undecenoyloxybenzenesulfonate (UDOBS or C₁₁-OBS with unsaturation in the 10 position); decanoyloxybenzoic acid (DOBA); (6-octanamidocaproyl)oxybenzenesulfonate; (6-nonanamidocaproyl) oxybenzenesulfonate; (6-decanamidocaproyl)oxybenzenesulfonate and mixtures thereof;
d) said preformed peracid comprises a material selected from the group consisting of peroxymonosulfuric acids; perimidic acids; percabonic acids; percarboxilic acids and salts of said acids;
e) said diacyl peroxide comprises a material selected from the group consisting of dinonanoyl peroxide, didecanoyl peroxide, diundecanoyl peroxide, dilauroyl peroxide, dibenzoyl peroxide, di-(3,5,5-trimethyl hexanoyl) peroxide and mixtures thereof;
f) said hydrogen peroxide source comprises a material selected from the group consisting of a perborate, a percarbonate, a peroxyhydrate, a persulfate and mixtures thereof; and
g) said enzyme comprises a material selected from the group consisting of peroxidases, proteases, lipases, phospholipases, cellobiohydrolases, cellobiose dehydrogenases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccases, amylases, and mixtures thereof.

4. The delivery particle of claim 2, wherein:
a) said polyvinyl alcohol comprises a polyvinyl alcohol variant having a degree of hydrolysis from about 80 mol % to about 99 mol %; and a molecular weight from about 10,000 gram/mol to about 750,000 gram/mol;
b) said polyvinyl acetate comprises a polyvinyl acetate variant having a degree of polymerization from about 150 to about 5,000; and
c) said cellulose acetate comprises a cellulose acetate variant having a molecular weight from about 30,000 to about 50,000 gram/mol.

5. The delivery particle of claim 2 wherein:
a) said water soluble and/or water dispersible non-reducing polysaccharide comprises a material selected from the group consisting of xanthan gum, diutan gum, guar gum, gellan gum, carrageenan, synergistic gum systems and mixtures thereof; and
b) said water soluble and/or water dispersible acrylate derivative has a glass transition temperature from about 50° C. to about 130° C.

6. The delivery particle of claim 2, said matrix binder having a centrifuge retention capacity from about 2 gram/gram to about 500 gram/gram.

7. The delivery particle of claim 1, wherein said delivery particle comprises:
a) a single matrix comprising one or more matrix binders and a plurality of matrix benefit agent cores that comprise the same or a different material; or
b) a plurality of matrices, each of said matrices independently comprising one or more matrix binders and a plurality matrix benefit agent cores that comprise the same or a different material, said plurality of matrices being encapsulated by or embedded in said shell material.

8. The delivery particle of claim 1, said delivery particle having a stability index of from about 0.80 to about 1.

9. The delivery particle of claim 1, said delivery particle having a release index of from about 0.25 to about 1.

10. The delivery particle of claim 1, said delivery particle having a matrix to shell material mass ratio of from about 20:80 to about 90:10.

11. The delivery particle of claim 1, said delivery particle having a matrix binder to shell mass ratio of from about 50:50 to about 3:97.

12. The delivery particle of claim 1, said delivery particle comprising an additional outer layer, said outer layer comprising a second shell material, a deposition aid polymer and/or mixtures thereof.

13. The delivery particle of claim 12, wherein said deposition aid polymer comprises polyvinylformamide.

14. A consumer product comprising the delivery particle of claim 1 and an adjunct ingredient.

15. A consumer product according to claim 14, said consumer product comprising a material selected from the group consisting of an external structuring system, an anti-agglomeration agent and mixtures thereof.

16. A consumer product according to claim 15, wherein said external structuring system comprises a hydrogenated castor oil derivative.

17. A consumer product according to claim 14, said consumer product comprising a material selected from:
a) an anionic surfactant and/or a nonionic surfactant;
b) a solvent;
c) water; and
d) optionally, one or more materials selected from the group consisting of:
(i) a bleach compatible clay clean polymer;
(ii) a brightener;
(iii) a builder; and
(iv) a chelant.

18. A consumer product according to claim 14, wherein said consumer product comprises:
a. from 0.0001% to 8% by weight of a detersive enzyme, and
b. has a neat pH from 6.5 to 10.5.

19. A consumer product according to claim 18, wherein said detersive enzyme comprises an enzyme selected from the group consisting of: lipase, protease, amylase, cellulase, pectate lyase, xyloglucanase, and mixtures thereof.

20. A consumer product according to claim 14, wherein said consumer product comprises:
a. from 0.1% to 12% by weight of the bleach or bleach system, and
b. has a neat pH of from 6.5 to 10.5.

21. A consumer product according to claim 14, wherein said consumer product is enclosed within a water soluble pouch material.

22. A method of treating and/or cleaning a situs, said method comprising
a. optionally, washing and/or rinsing said situs;
b. contacting said situs with a consumer product according to claim 14; and
c. optionally, washing and/or rinsing said situs.

23. A situs treated with the consumer product according to claim 14.

24. A process of making a consumer product that comprises a consumer product adjunct material and a delivery particle, said process comprising:
a) preparing a first solution comprising, based on total solution weight, from about 0.1% to about 10% of a matrix binder that is suspended and/or dissolved in said first solution, and one or more solvents;
b) preparing a first composition comprising, based on total composition weight, from about 0.1% to about 30% of a matrix benefit agent that is suspended and/or dissolved in said first solution;
c) optionally, adding an external structuring system, based on total solution weight, from about 0.01% to about 2%, to said first composition;
d) spraying said first composition in a chamber at a temperature of from about 25° C. to about 140° C. to form matrices containing a plurality of matrix benefit agent cores;
e) collecting said matrices;
f) preparing a second solution comprising, based on total solution weight, from about 1% to about 20% of a shell material that is suspended and/or dissolved in said second solution, and one or more solvents;
g) optionally, adding a plasticizer, based on total solution weight, from about 0.01% to about 2%, to said second solution;
h) preparing a third composition comprising, based on total composition weight, from about 1% to about 10% of said matrices that are suspended in said second solution or said third composition;
i) optionally, adding an external structuring system based on total solution weight, from about 0.01% to about 2%, to said third composition;
j) spraying said second composition in a chamber at a temperature of from about 25° C. to about 140° C. to form a delivery particle;
k) collecting said delivery particle; and
l) combining said delivery particle with one or more consumer product adjuncts, a deposition aid polymer, or mixtures thereof.

25. A process of making a consumer product that comprises a consumer product adjunct material and a delivery particle, said process comprising:
a) preparing a first solution comprising, based on total solution weight, from about 0.1% to about 10% of a matrix binder that is suspended and/or dissolved in said first solution, and one or more solvents;
b) preparing a first composition comprising, based on total composition weight, from about 0.1% to about 30% of a matrix benefit agent that is suspended and/or dissolved in said first solution;
c) optionally, adding an external structuring system, based on total solution weight, from about 0.01% to about 2%, to said third composition;
d) spraying said first composition in a chamber at a temperature of from about 25° C. to about 140° C. to form matrices containing a plurality of matrix benefit agent cores;
e) collecting said matrix particles;
f) preparing a second solution comprising, based on total solution weight, from about 1% to about 20% of a shell material that is suspended and/or dissolved in said second solution, and one or more solvents;
g) optionally, preparing a second composition comprising, based on total solution weight, from about 0.01% to about 2% of a plasticizer and said second solution;
h) optionally, combining an anti-agglomeration agent with said second solution or second composition;
i) fluidizing said matrices in a spouted bed;
j) spraying said second solution or second composition on said matrices at a temperature of from about 25° C. to about 100° C. to form a delivery particle;
k) collecting said delivery particle, and
l) combining said delivery particle with one or more consumer product adjuncts, a deposition aid polymer, or mixtures thereof.

26. A process of making a consumer product that comprises a consumer product adjunct material and a delivery particle, said process comprising:
a) preparing a first solution comprising, based on total solution weight, from about 0.1% to about 10% of a matrix binder that is suspended and/or dissolved in said first solution, and one or more solvents;
b) preparing a first composition comprising, based on total composition weight, from about 0.1% to about 30% of a matrix benefit agent core that is suspended and/or dissolved in said first solution;
c) optionally, preparing a second composition comprising, based on total composition weight, from about 0.05 to 3% of an external structuring system and said first said composition;
d) preparing a second solution comprising, based on total solution weight, from about 1% to about 20% of a shell material that is suspended and/or dissolved in said second solution, and one or more solvents;
e) spraying said first or second composition and said second solution in a chamber at a temperature of from about 25° C. to about 140° C. by using a concentric nozzle or a electrified coaxial needle to form a delivery particle;
f) collecting said delivery particle; and
g) combining said delivery particle with one or more consumer product adjuncts, a deposition aid polymer, or mixtures thereof.
